(19) United States
(12) Patent Application Publication
(10) Pub. No.: US 2011/0300499 A1
(43) Pub. Date: Dec. 8, 2011

(54) MULTIPLE TEMPERATURE POINT CONTROL HEATER SYSTEM

(76) Inventors: Leung Kwok Wai Simon, Tai Po (HK); Mahmoud Ismail, Parkview (HK)

(21) Appl. No.: 12/899,779

(22) Filed: Oct. 7, 2010

Related U.S. Application Data
(60) Provisional application No. 61/249,279, filed on Oct. 7, 2009.

(51) Int. Cl. F27D 19/00

(52) U.S. Cl. 432/36

(57) ABSTRACT

A multi-zone portable heater is provided having an oscillating heater and a plurality of remote sensors. The plurality of remote sensors are radially positionable about the oscillating heater in a spaced apart configuration, each defining a heating region. The remote sensors read a region temperature in their corresponding heating region and can transmits the corresponding region temperature to the heater signal transmitter/receiver. Alternatively, the oscillating heater can transmit a set temperature to each of the plurality of remote sensors, where the remote sensors calculates a region temperature difference between the read region temperature and the set temperature. The region temperature difference being transmitted to the oscillating heater. In this manner, the operational parameters of the oscillating heater can be selectively controlled for each of the regions.

### CROSS-REFERENCE TO RELATED APPLICATION

The present invention claims priority to U.S. Provisional Application No. 61/249,279 entitled MULTIPLE TEMPERATURE POINT CONTROL HEATER SYSTEM, filed on Oct. 7, 2009, the contents of which are herein incorporated by reference in it entirety.

### FIELD OF THE INVENTION

The invention relates portable space heaters, and more particularly to a system for controlling a multi-zone space heater.

### BACKGROUND OF THE INVENTION

Portable heaters are intended to be placed on floors, counters or other surfaces. When desired, these heaters can be easily moved from one place to another. These devices often include a housing which is fixedly mounted or integrally formed on a supporting base. Because of the mounting arrangement of the housing on the supporting base, the angular zone covered by the emitted air is fixed. With these style heaters, when the user wishes to alter the angular zone of the emitted air, the user must reposition the heater so as to face the area intended to be heated.

It has been proposed, in U.S. Pat. No. 4,703,152 to provide a heater with an oscillating mechanism. The use of an oscillating mechanism on a standard heater enables the user to alter or enlarge the angular zone of the emitted air such that a greater area is capable of being covered by the heater.

### SUMMARY OF THE INVENTION

The present disclosure provides a multi zone portable heater having an oscillating heater and a plurality of remote sensors. The oscillating heater includes a base and a housing operably connected to the base with an oscillating mechanism. A heating element and blower are disposed within the housing, where the blower is positioned to direct an air flow past the heating element and through the outlet opening. The oscillating heater further includes a transmitter/receiver and temperature selector operably connected to a heater controller. Using inputs from the transmitter/receiver and temperature selector the controller can control the operational parameters of the blower, heating element, and the oscillation mechanism.

Each of the plurality of remote sensors include a temperature sensor and a sensor signal transmitter/receiver operable connected to a sensor controller. The remote sensor can also include a digital display. The remote sensors are radially positionable about the oscillating heater in a spaced apart configuration, each defining a heating region. In this manner, each of the remote sensor reads the temperature in its region.

In a method of use, the remote sensors transmit the region's temperature to the oscillating heater. The heater control determines the temperature difference between a set temperature and the region temperature, for each region. The heater controller uses this information to optionally control the operational parameters of the heating element, blower, and oscillation mechanism for each of the regions.

In another method of use, the oscillating heater transmits a set temperature to each of the remote sensors. Each on the remote sensors calculates the temperature difference for its region, the difference between the set temperature and the region temperature. The remote sensors transmit their temperature difference to the oscillating heater. The heater controller uses this information to optionally control the operational parameters of the heating element, blower, and oscillation mechanism for each of the regions.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a prior art oscillating heater;

FIG. 2 depicts a multi-zone oscillating heater system of the present disclosure;

FIG. 3 depicts a diagram of the control system of the multi-zone oscillating heater system of FIG. 2;

FIG. 4. depicts a diagram of a remote sensor for use with the multi-zone oscillating heater system of the present disclosure;

FIG. 5 depicts a first exemplary method of operation of the multi-zone oscillating heater system of the present disclosure;

FIG. 6 depicts second exemplary method of operation of the multi-zone oscillating heater system of the present disclosure;

FIG. 7 depicts a third exemplary method of operation of the multi-zone oscillating heater system of the present disclosure;

FIG. 8 depicts a forth exemplary method of operation of the heater multi-zone oscillating heater system of the present disclosure;

FIG. 9 depicts an alternative method of operation of the remote sensor of the present disclosure; and

FIG. 10 depicts another exemplary method of operation of the multi-zone oscillating heater system of the present disclosure.

### DETAILED DESCRIPTION OF THE INVENTION

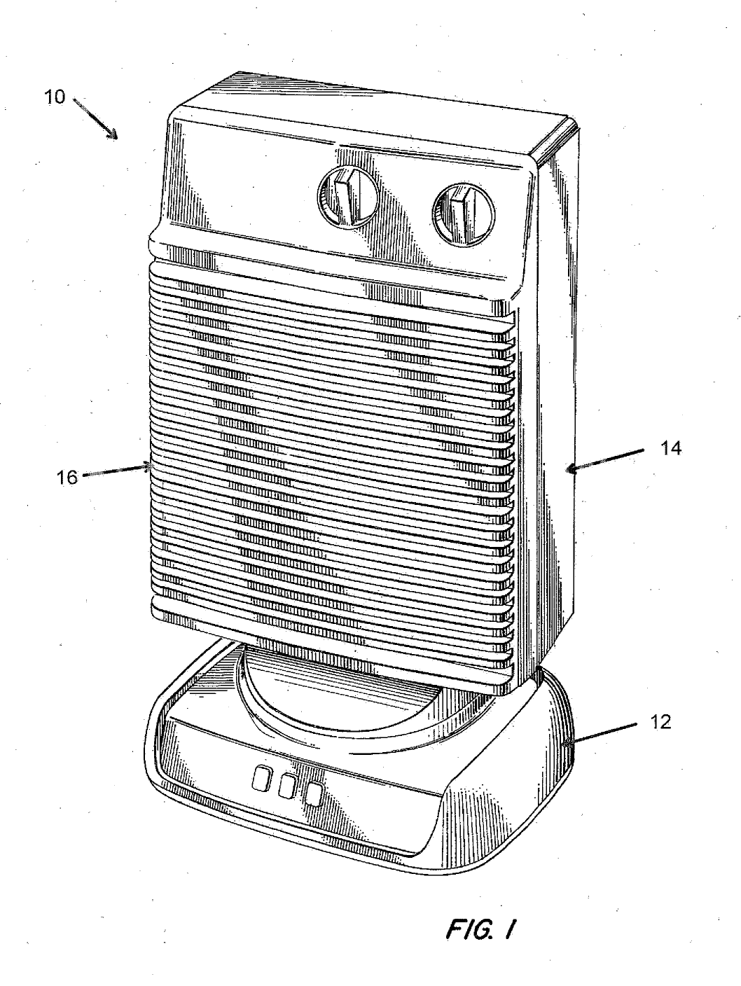

Referring now to the drawings, FIG. 1 depicts a prior art oscillating heater 10. The oscillating heater 10 includes a base 12 with a housing 14 rotatably mounted thereto. The housing 14 has a plurality of openings, including inlet openings (not shown) and outlet openings 15. The housing openings can be different in configuration from being designed as grills, covered with wire mesh, not covered at all, or designed in any manner which will allow air to flow there through.

The heater 10 includes a heat source within the housing 14. The heat source can include an electrically driven heater element. A blower is in fluid communication with the heating element, and blows air past the heater element and out of the outlet openings 16 in the housing 12. It will be readily apparent to one of ordinary skill in the art that there are other known heat sources that can be used with the present invention. Additional types of heat sources include plate heaters and coil heaters, to name a few.

The blower used in conjunction with the oscillating heater 10 can be any means which forces air past the heat source and through the at least one outlet openings 16 in the housing 12. Such blowers include fans and “squirrel cage” blowers. Similar to the heat source, one of skill in the art will recognize that there are many variations to the style and type of blower which can be used with the present invention. Typically, however, the style and type of blower used will be matched with the style and type of heat source used.

The oscillating heater 10 includes an oscillating mechanism, which converts an input motion, such as a circular or rotary motion from a motor, into oscillation. For the purposes of this discussion, oscillation will be understood to refer to a repetitive motion which causes the heating units to discharge heat in a repeating pattern of directions. Within the context of a heater, oscillation is a motion wherein the heater units' rotational axis sweeps through an arc, subsequently moving in reverse direction through the same arc, returning to its original position.

An exemplary oscillation mechanism can include a motor, a gear having a plurality of teeth, and a track having a plurality of teeth. The motor and the gear are attached to housing 14, the track is provided on the top surface of base 12, and the gear is positioned within the track. The actuation of the motor causes the relative rotation of the gear such that the teeth of the gear engage the teeth of the track and force the gear to follow the pattern of the track. Due to the fact that the motor and gear are attached to the housing, the movement of the gear within the track will cause the housing to oscillate with respect to the base. When the gear reaches the limit of the track, the motor will change direction and force the gear to move in the reverse direction as that previously traveled within the track. This pattern will repeat until power to the oscillation motor is removed. The speed of oscillation is controlled by the speed of the motor, and can be adjusted by a user.

The oscillating mechanism described above is but one mechanism which can be effectively utilized to oscillate the heating units with respect to each other. Other mechanisms can alternatively effectively provide for oscillation of the heater units of the present invention.

Exemplary oscillating heaters are provided in U.S. Pat. No. 4,703,152 entitled Tiltable and Adjustable Oscillatable Portable Electric Heater/Fan and U.S. Pat. No. 6,321,034 entitled Pivotable Heaters, the contents of which are herein incorporated by reference in their entirety.

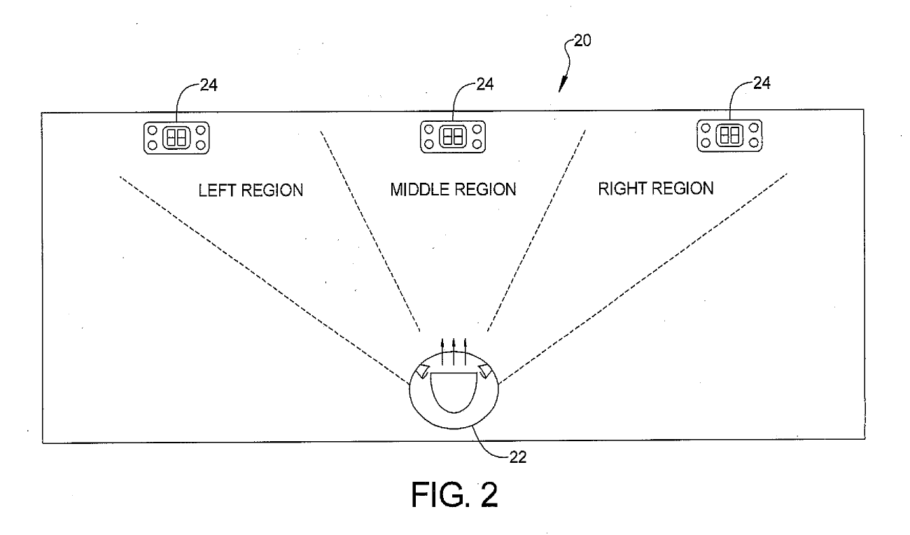

Referring to FIG. 2, a portably multi-zone room heater system 20 is provided having an oscillating heater 22 and a plurality of remote sensors 24. As note above, the oscillating heater 22 includes a heat element within a housing. A blower positioned in the housing is in fluid communication with the heating element, and blows air past the heater element and out of the outlet openings in the housing. An oscillating mechanism is provided to impart an oscillating motion on the housing.

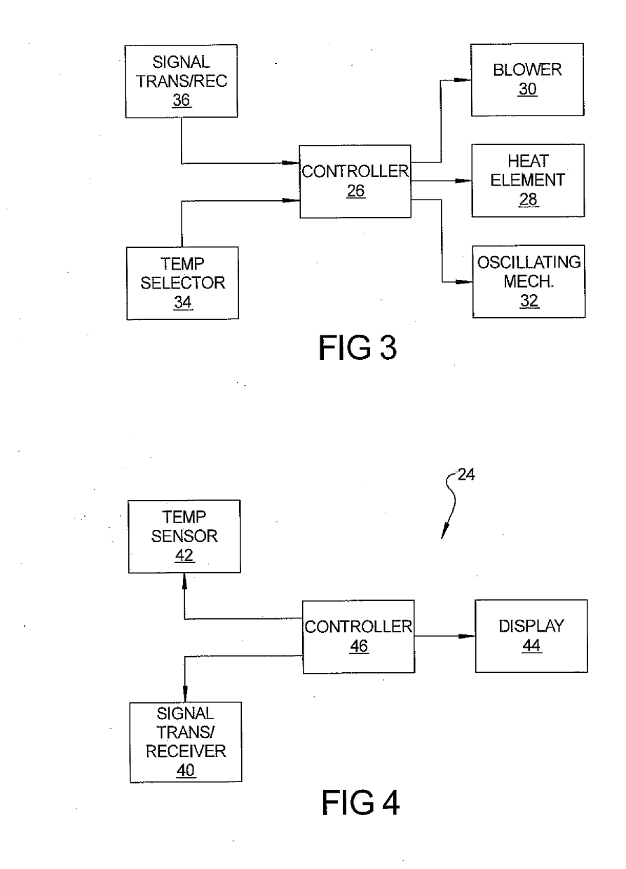

The oscillating heater 22 further includes a controller 26, such as a microprocessor, for controlling the operation of the oscillating heater 22. Referring to FIG. 3, the controller 26 can control the operational parameters of the oscillating heater 22, including the temperature of the heat element 28, the blower speed 30, and the speed of the oscillation mechanism 32.

A temperature selector 34 is provided on the oscillating heater 22, and is operably connected to controller 26. The temperature selector 34 permits a user to set a desired room temperature. In response to the set temperature, the controller 26 sets the initially operational parameters of the oscillating heater 22. Alternatively, the operating parameter can be manually set.

Additionally, the temperature selector 34 permits a user to adjust the desired room temperature during operation of the oscillating heater 22. The controller 26 would then use the new set temperature to adjust the operational parameters of the oscillating fan 22.

A signal transmitter and receiver 36 is also provided in the oscillating heater 26, and is operably connected to the controller 26. The signal transmitter and receiver 36 is configured to transmit and receive a signal from each of the plurality of remote sensors 24. The signal transmitter and receiver 36 can, but not limited to, be a radio frequency (RF) transmitter and receiver. In operation, the signal transmitter transmits 36 the set temperature to the plurality of remote sensors 24.

The plurality of remote sensors 24 are positionable about a room, dividing the room into separate regions (zones). For example, the plurality of remote sensors 24 can include three remote sensors 24 radially positioned about the oscillating heater 22. (See FIG. 2) The placement of the three remote sensors 22 divides the room into three regions; left, middle, and right region. The three remote sensors 22 can be placed such that each of the three regions has an equal angular distance. Alternatively, the three remote sensors 22 can be placed such that each of the three regions has an unequal angular distance.

It is also envisioned that the user can define the separate regions using the controller. The user can define either equal or unequal regions. Upon defining the separate regions, the user positions a remote sensor in each of the regions.

Referring to FIG. 4, each of the plurality of remote sensors 24 includes a signal receiver and transmitter 40 for receiving and transmitting data from and to the oscillating heater 22, a temperature sensor 42 for reading the current temperature in the region, and a controller 46. A digital display 44 can further be provided on each of the remote sensors 24 to display the current region temperature, the set temperature, or the temperature difference between the set temperature and the current temperature.

In operation, the signal receiver and transmitter 40 of a remote sensors 24 receives a signal from the oscillating heater 22 indicating the set temperature. The temperature sensor 42 of the remote sensor 24 reads the current temperature in its region. The controller 46 of the remote sensor 24 calculates the ΔT for the region, where:

ΔT=Set Temperature−Current Temperature.

The ΔT is transmitted to the oscillating heater 22. In addition to the transmitting the ΔT, each of the remote sensor 24 can also transmit a unique identification code to the oscillating heater 22. The unique identification is used by the oscillating heater 22 to correlate the transmitted data to a specific region.

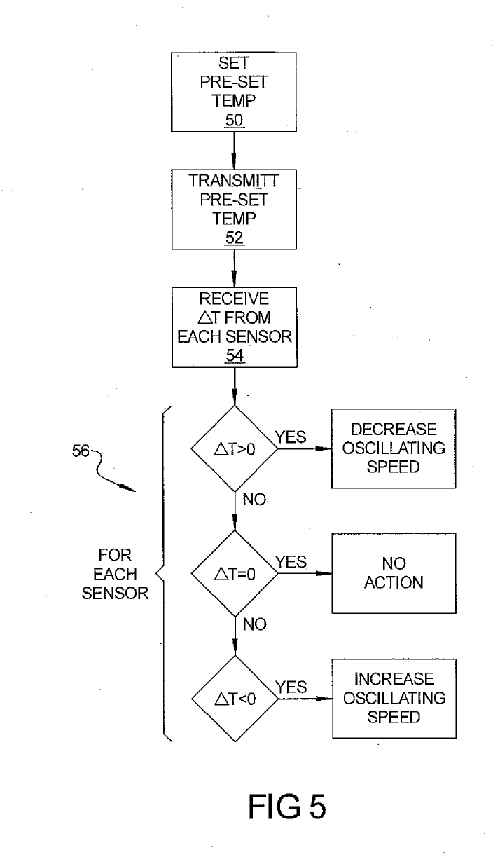

In a method of use, the oscillating heater 22 is positioned within a room. The plurality of remote sensors 24 are radially positioned about the oscillating heater 22, dividing the room into a plurality of regions. Referring to FIG. 5, a user sets 50 a desired temperature for the room, where the controller 26 sets the initially operational parameters of the oscillating heater 22. Upon activation of the oscillating heater 22, the controller 26 transmits 52 the set temperature to the plurality of remote sensors 24.

After a preset time interval, the temperature sensor 42 for each of remote sensors 24 reads the current region temperature and calculates the ΔT for its regions. Each of the remote sensors 24 transmits the calculated ΔT and its unique identification signal to the oscillation heater 22. The heater controller 26 receives the signals 54 from each of the remote sensors 24, comparing and adjusting 56 the operation parameters for each of the regions in response thereto. For example:

| Region ΔT | Region Oscillation Speed |
|---|---|
| ΔT > 0 | Decrease |
| ΔT = 0 | No Change |
| ΔT < 0 | Increase |

The region oscillation speed is the speed at which the housing rotated through a region. In the initially setup condition, the region oscillation speed can be equal for all the regions.

At preset time intervals the remote sensors 24 repeat the process, reading the current region temperature and calculating the ΔT for its regions. Each of the remote sensors 24 then transmits the calculated ΔT and its unique identification signal to the oscillation heater 22. The controller 26 receives the signals from each of the remote sensors 24 and adjusts the operation parameters for each of the regions. This process is continually performed during the operation of the oscillating heater 22.

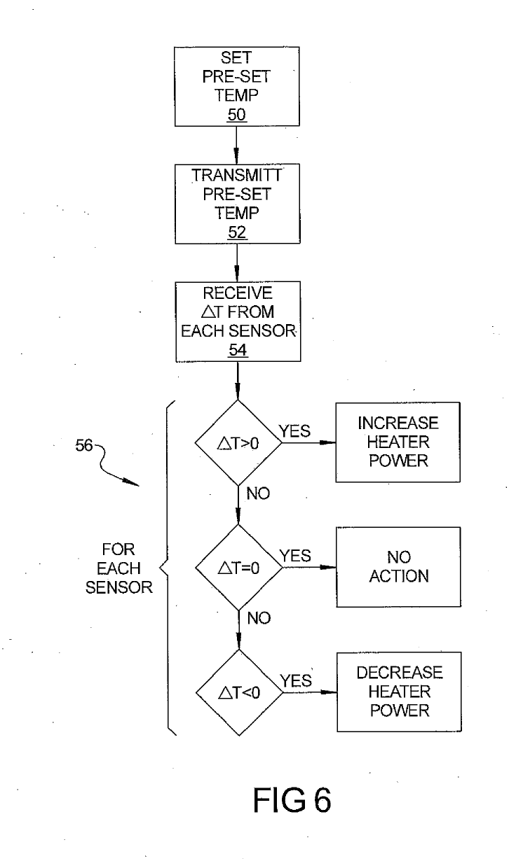

Referring to FIG. 6, in another method of operation the temperature sensors 42 for each of remote sensors 24 reads the current region temperature and calculates the ΔT for its regions. Each of the remote sensors 24 then transmits the calculated ΔT and its unique identification signal to the oscillation heater 22. The heater controller 26 receives signals 54 from each of the remote sensors 24, comparing and adjusting 56 the operation parameters for each of the regions in response thereto. For example:

| Region ΔT | Region Heater Power |
|---|---|
| ΔT > 0 | Increase |
| ΔT = 0 | No Change |
| ΔT < 0 | Decrease |

If the ΔT<<0 for a region, the oscillating heater can operate in a blower only mode through the region.

At preset time intervals the remote sensors 24 repeat the process, reading the current region temperature and calculating the ΔT for its regions. Each of the remote sensors 24 then transmits the calculated ΔT and its unique identification signal to the oscillation heater 22. The controller 26 receives the signals from each of the remote sensors 24 and adjusts the operation parameters for each of the regions. This process is continually performed during the operation of the oscillating heater.

In another method of operation, after a preset time interval, the temperature sensors 42 for each of remote sensors 24 reads the current region temperature and calculates the ΔT for its regions. Each of the remote sensors 24 then transmits the calculated ΔT and its unique identification signal to the oscillation heater 22. The heater controller 26 receives signals 54 from each of the remote sensors 24, comparing and adjusting the operation parameters for each of the regions in response thereto. For example:

| Region ΔT | Region Blower Speed |
|---|---|
| ΔT > 0 | Increase |
| ΔT = 0 | No Change |
| ΔT < 0 | Decrease |

At preset time intervals the remote sensors 24 repeat the process, reading the current region temperature and calculating the ΔT for its regions. Each of the remote sensors 24 then transmits the calculated ΔT and its unique identification signal to the oscillation heater 22. The controller 26 receives the signals from each of the remote sensors 24 and adjusts the operation parameter for each of the regions. This process is continually performed during the operation of the oscillating heater 22.

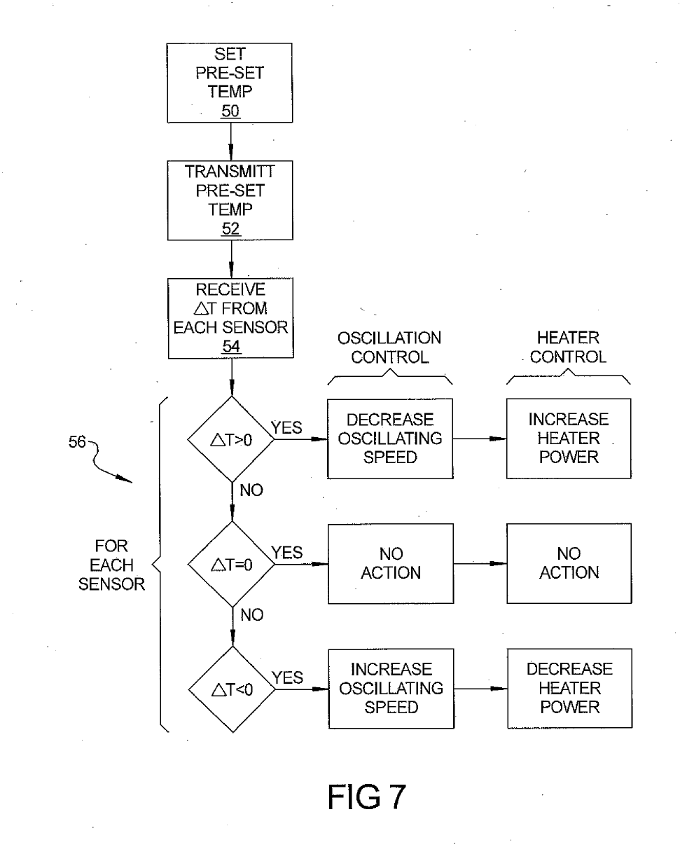

In addition to adjusting a single operational parameter, the controller 26 can adjust multiple operational parameters of the oscillating heater 22, including the oscillating speed, heater element power, and the blower speed. Referring to FIG. 7, after a preset time interval, the temperature sensors 42 for each of remote sensors 24 reads the current region temperature and calculates the ΔT for its regions. Each of the remote sensors 24 transmits the calculated ΔT and its unique identification signal to the oscillation heater 22. The heater controller 26 receives signals 54 from each of the remote sensors 24, comparing and adjusting 56 the operation parameters for each of the regions. For example:

| | Regions | Region |
|---|---|---|
| Region ΔT | Oscillating Speed | Heater Power |
| ΔT > 0 | Decrease | Increase |
| ΔT = 0 | No Change | No Change |
| ΔT < 0 | Increase | Decrease |

If the ΔT<<0 for a region, the oscillating heater can operate in a blower only mode through the region.

At preset time intervals the remote sensors 24 repeat the process, reading the current region temperature and calculating the ΔT for its regions. Each of the remote sensors 24 then transmits the calculated ΔT and its unique identification signal to the oscillation heater 22. The controller 26 receives the signals from each of the remote sensors 24 and adjusts the operation parameters for each of the regions. This process is continually performed during the operation of the oscillating heater.

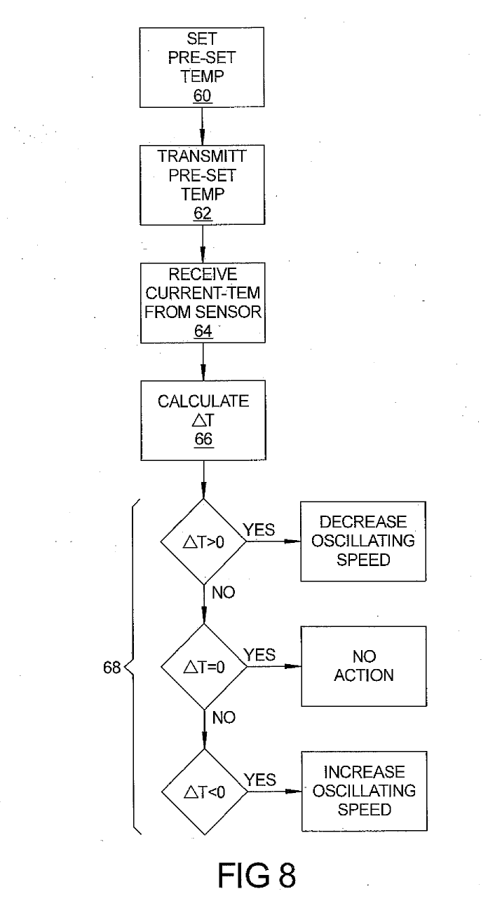

In the above example, each of the remote sensors 24 calculates the ΔT for its own region. However, it is contemplate that the controller can calculate the ΔT for each of the regions. In such a case, each of the remote sensors would read the current region temperature and then transmit the current region temperature and its unique identification signal to the controller. Referring to FIG. 8, using this information the controller calculates the ΔT for each of the regions and adjusts the operation parameters of the oscillating heater 22 for each of the regions.

Specifically, a user sets 60 a desired temperature for the room, where the controller 26 sets the initially operational parameters of the oscillating heater 22. Upon activation of the oscillating heater 22, the controller 26 transmits 62 the set temperature to the plurality of remote sensors 24.

After a preset time interval, the temperature sensor 42 for each of remote sensors 24 reads the current temperature and for its regions and transmits the current temperature and its unique identification signal to the oscillation heater 22. The heater controller 26 receives signals 64 from each of the remote sensors 24, and calculates ΔT 66 for each of the regions. The controller compares and adjusts 68 the operation parameters for each of the regions. For example:

| Region ΔT | Region Oscillation Speed |
|---|---|
| ΔT > 0 | Decrease |
| ΔT = 0 | No Change |
| ΔT < 0 | Increase |

At preset time intervals the remote sensors 24 repeat the process, reading the current region temperature for its regions. Each of the remote sensors 24 then transmits current temperature and its unique identification signal to the oscillation heater 22. The controller 26 receives the signals from each of the remote sensors 24 and adjusts the operation parameter for each of the regions. This process is continually performed during the operation of the oscillating heater.

As previously described, the controller 26 can adjust a single or the multiple operational parameters of the oscillating heater 22, including, but not limited to, the oscillating speed, heater element power, and the blower speed.

In another method of use, the region temperatures can be individually set. The oscillating heater 22 is positioned within a room and the plurality of remote sensors 24 are radially positioned about the oscillating heater 22, dividing the room into a plurality of regions. A user sets a desired temperature for each of the regions, where the controller 26 sets the initially operational parameters of the oscillating heater 22. The desired temperature for each region can be the same or different for each region in the room. Upon activation of the oscillating heater 22, the controller 26 transmits the set temperature(s) to each of remote sensors 24.

After a preset time interval, each of the remote sensors 24 read the current region temperature and calculates the ΔT for its region. The ΔT for each region is based on the region's set temperature. Each of the remote sensors 24 then transmits the calculated region ΔT and its unique identification signal to the oscillation heater 22. The controller 26 receives signals from each of the remote sensors 24 and adjusts the operation parameters for each of the regions. For example:

| Region ΔT | Region Oscillation Speed |
|---|---|
| ΔT > 0 | Decrease |
| ΔT = 0 | No Change |
| ΔT < 0 | Increase |

The region oscillation speed is the speed at which the housing rotated through a region. In the initially preset, the region oscillation speed can be equal for all the regions.

At preset time intervals the remote sensors 24 repeat the process, reading the current region temperature and calculating the ΔT for its regions. Each of the remote sensors 24 then transmits the calculated ΔT and its unique identification signal to the oscillation heater 22. The controller 26 receives the signals from each of the remote sensors 24 and adjusts the operation parameters for each of the regions. This process is continually performed during the operation of the oscillating heater.

In the above example, each of the remote sensors 24 calculates the ΔT for its own region. However, it is contemplate that the controller can calculate the ΔT for each of the regions. In such a case, each of the remote sensors would read the current region temperature and then transmit the current region temperature and its unique identification signal to the controller. Using this information, the controller calculates the ΔT for each of the regions and adjusts the operation parameters of the oscillating heater 22 for each of the regions.

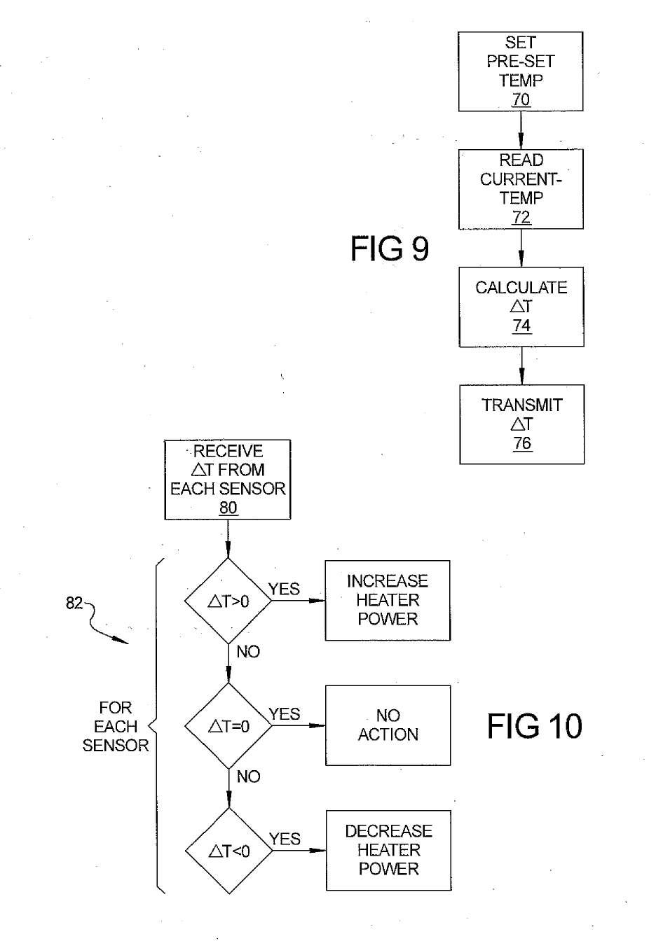

In the above described systems, the set temperature is set on the oscillating heater 22. Referring to FIG. 9, a user can set the set temperature on each of the remote sensors 24, where the set temperature can be the same or different for each of the regions. It is also contemplated that the set temperature can be set on one of the remote sensors 24, which then transmits the set temperature to the other remote sensors 24, either directly or through the oscillating heater 22.

Each of the remote sensors 24 reads the current region temperature in its region 72 and calculates the ΔT for its region 74. Each of the remote sensors 24 then transmits 76 the calculated ΔT and its unique identification signal to the oscillation heater 22.

Referring to FIG. 10, the controller 26 receives signals 80, the ΔT for each of the regions, from each of the remote sensors 24 and sets the operational parameters for each of the regions. Then compares and adjusts 68 the operation parameters for each of the regions. For example:

| Region ΔT | Region Oscillation Speed |
|---|---|
| ΔT > 0 | Decrease |
| ΔT = 0 | No Change |
| ΔT < 0 | Increase |

At preset time intervals the remote sensors 24 repeats the process, reading the current region temperature and calculating the ΔT for its regions. Each of the remote sensors 24 then transmits the calculated ΔT and its unique identification signal to the oscillation heater 22. The controller 26 receives the signals from each of the remote sensors 24 and adjusts the operation parameters for each of the regions. This process is continually performed during the operation of the oscillating heater.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A multi-region portable heater comprising:
an oscillating heater including a heater signal transmitter/receiver operably connected to a heater controller; and
a remote sensor.

2. A multi-region portable heater as set forth in claim 1, the oscillating heater comprising:
a base;
a housing operably connected to the base and including an inlet opening and an outlet opening;
a heating element disposed within the housing;
a blower mounted within the housing and positioned to directed an air flow past the heating element and through the outlet opening; and
an oscillation mechanism connected between the base and housing.

3. A multi-region portable heater as set forth in claim 2, where in the heater controller is operably connected to the blower, heating element, and the oscillation mechanism.

4. A multi-region portable heater as set forth in claim 3, further comprising a temperature selector operably connected to the heater controller, such that the heater controller controls the operational parameters of the blower, heating element, and oscillation mechanism in response to signals received from the temperature selector and the heater signal transmitter/receiver.

5. A multi-region portable heater assembly as set forth in claim 4, wherein the remote sensor comprises a temperature sensor and a sensor signal transmitter/receiver operable connected to a sensor controller.

6. A multi-region portable heater assembly as set forth in claim 5, wherein the remote sensor is positionable a distance from the oscillating heater, such that the temperature sensor reads a remote temperature.

7. A multi-region portable heater assembly as set forth in claim 6, wherein the sensor signal transmitter/receiver transmits the remote temperature to the heater signal transmitter/receiver.

8. A multi-region portable heater assembly as set forth in claim 6, wherein the heater signal transmitter/receiver transmits a set temperature to the remoter sensor.

9. A multi-region portable heater assembly as set forth in claim 8, where the sensor controller calculates the temperature difference between the remote temperature and the set temperature, the sensor transmitter/receiver transmitting the temperature difference to the heater signal transmitter/receiver.

10. A multi-region portable heater transmitter as set forth in claim 1, further comprising a plurality of remote sensors radially positionable about the oscillating heater.

11. A multi-region portable heater comprising:
an oscillating heater including,
a base,
a housing operably connected to the base and including an inlet opening and an outlet opening,
a heating element disposed within the housing,
a blower mounted within the housing and positioned to directed an air flow past the heating element and through the outlet opening,
an oscillation mechanism connected between the base and housing,
a heater signal transmitter/receiver and a temperature selector operably connected to provide input signals to a heater controller, where in the heater controller is operably connected to control the operational parameters of the blower, heating element, and oscillating mechanism in response to input signals received from the temperature selector and the heater signal transmitter/receiver; and
a plurality of remote sensors radially positionable about the oscillating heater in a spaced apart configuration each defining a heating region.

12. A multi-region portable heater assembly as set forth in claim 11, wherein each of the plurality of remote sensors comprise a temperature sensor and a sensor signal transmitter/receiver operably connected to a sensor controller.

13. A multi-region portable heater assembly as set forth in claim 12, wherein the temperature sensors in each of the remote sensors reads a regions temperature in the corresponding heating region.

14. A multi-region portable heater assembly as set forth in claim 13, wherein the sensor signal transmitter/receiver in each of the remote sensors transmits the corresponding region temperature to the heater signal transmitter/receiver.

15. A multi-region portable heater assembly as set forth in claim 13, where in the heater signal transmitter/receiver transmits a set temperature to each of the plurality of remote sensors.

16. A multi-region portable heater assembly as set forth in claim 15, where the sensor controller in each of the remote sensors calculates a region temperature difference between the read region temperature and the set temperature, each of the sensor transmitters/receives transmitting the region temperature difference to the heater signal transmitter/receiver.

17. A method of heating a room comprising:
positioning an oscillating heater in a room, the oscillating heater including:
a base,
a housing operably connected to the base and including an inlet opening and an outlet opening,
a heating element disposed within the housing,
a blower mounted within the housing and positioned to directed an air flow past the heating element and through the outlet opening,
an oscillation mechanism connected between the base and housing,
a heater signal transmitter/receiver and a temperature selector operably connected to provide input signals to a heater controller, where in the heater controller is operably connected to control the operational parameters of the blower, heating element, and oscillating mechanism in response to input signals received from the temperature selector and the heater signal transmitter/receiver; and
positioning plurality of remote sensors radially about the oscillating heater in a spaced apart configuration, each of the remote defining a heating region, the remote sensors each including a temperature sensor and a sensor signal transmitter/receiver operably connected to a sensor controller;
setting a set temperature on the oscillating heater;
transmitting the set temperature to each of the remote sensors;
each of the remote sensors reading the region temperature;
each of the remote sensors calculating the temperature difference between the set temperature and the read temperature;
each of the remote sensors transmitting the temperature difference to the oscillating heater;
adjusting the operating parameters of one of the heating element, blower, and osculation mechanism in each heating region in response to the received temperature differences.
